(19) United States
(12) Patent Application Publication
(10) Pub. No.: US 2022/0020366 A1
(43) Pub. Date: Jan. 20, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventors: Nami TOKUNAGA, Kanagawa (JP); Shinya YAMAZAKI, Kanagawa (JP); Tsuyoshi SAITO, Kanagawa (JP); Noriji KATO, Kanagawa (JP)

(73) Assignee: FUJIFILM BUSINESS INNOVATION CORP., Tokyo (JP)

(21) Appl. No.: 17/173,624

(22) Filed: Feb. 11, 2021

(30) Foreign Application Priority Data
Jul. 20, 2020 (JP) 2020-123486

(51) Int. Cl. G10L 15/22; G06F 3/14; G06F 3/16; G10L 15/18

(52) U.S. Cl. CPC G10L 15/22; G06F 3/14; G06Q 10/06398; G10L 15/1815; G06F 3/167

(57) ABSTRACT

An information processing apparatus includes a memory and a processor configured to make a division of a content of a talk input by a user into talk content elements for each of topics of the talk content elements, and change a display mode of digest information representing the content and to be displayed on a display screen of a third party. The display mode is changed on a basis of a relationship between the topics.

### CROSS-REFERENCE TO RELATED APPLICATIONS

This application is based on and claims priority under 35 USC 119 from Japanese Patent Application No. 2020-123486 filed Jul. 20, 2020.

### BACKGROUND

### (i) Technical Field

The present disclosure relates to an information processing apparatus and a non-transitory computer readable medium.

### (ii) Related Art

Japanese Patent No. 6616038 discloses a business talk navigation system including a speaker identification unit, a salesperson-speech classification unit, and a customer speech classification unit. The speaker identification unit identifies speeches of a salesperson and speeches of a customer by analyzing the audio of a series of conversations. The salesperson-speech classification unit and the customer speech classification unit classify each speech of the salesperson and the customer on the basis of the content of the speech. The business talk navigation system suggests the content of a speech to be given next by the salesperson on the basis of combination of a classified salesperson speech and a classified customer speech.

Japanese Patent No. 6567128 discloses a talk support system. On the basis of first similarity that is similarity between sets of topics in topic transition information regarding topics appearing in talk text and second similarity that is similarity between character strings that are topic strings in the topic transition information regarding the topics appearing in the talk text, the talk support system classifies the talk text into talk flows each representing a predetermined talk form. On the basis of the first similarity and the second similarity, the talk support system determines a topic to which the topic of a real-time talk of an operator corresponds and a talk flow including the topic among the talk flows classified by the talk-classification processing unit. The talk support system thereby supports the operator in the talk on the basis of the topic of the real-time talk.

Japanese Unexamined Patent Application Publication No. 2019-28910 discloses a dialog analysis system including a dialog analysis unit, a dialog attribute extraction unit, a user interface unit, and a monitoring part extraction unit. The dialog analysis unit performs natural language analysis processing on text obtained by speech recognition and outputs the analysis result. The dialog attribute extraction unit assigns topic tags to respective dialogs on the basis of customer attribute data and records the dialogs as analyzed dialog data. The user interface unit extracts dialogs from the analyzed dialog data on the basis of designated conditions and displays a list of dialogs on the user terminal. The monitoring part extraction unit displays a first area for displaying speeches in the designated dialog in a time series and a second area for displaying a speech determined to have been described regarding a predetermined matter.

Japanese Unexamined Patent Application Publication No. 2002-288352 discloses a sales support system including communication terminal apparatuses and a server for sales support that are connected to each other via a network. In the sales support system, the server for sales support recognizes voice data transmitted from a communication terminal apparatus, determines an error in the content of a talk of a salesman on the basis of the recognized voice data, extracts a piece of sales support information related to the content of the recognized voice data from pieces of sales support information, and transmits a determined-error correction message and the extracted piece of sales support information to the communication terminal apparatuses via the network. Each communication terminal apparatus is capable of displaying the determined-error correction message and the extracted piece of sales support information that are transmitted from the server for sales support.

Japanese Unexamined Patent Application Publication No. 2020-4377 discloses a method for generating an animated preview including: processing multiple versions of a document including one or more slides for text differences and image differences between each of the multiple versions; providing a first version of the multiple versions of the document for display; and generating an animation transitioning the first version of the multiple versions of the document to a second version of the multiple versions of the document. The animation incorporates the text differences and the image differences between the first version and the second version.

### SUMMARY

For example, there is a case where a user such as a salesperson wants to receive advice about a business talk with a customer from a remote third party during the business talk.

However, for the third party to appropriately give the user advice, the third party needs to know the content of the talk including circumstances in the past.

Aspects of non-limiting embodiments of the present disclosure relate to providing an information processing apparatus and a non-transitory computer readable medium that enable a remote third party to more easily know the content of a talk between a user and a different person to give the user advice during the talk than in a configuration in which during the talk, the third party reads information generated by the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a memory and a processor configured to make a division of a content of a talk input by a user into talk content elements for each of topics of the talk content elements, and change a display mode of digest information representing the content and to be displayed on a display screen of a third party. The display mode is changed on a basis of a relationship between the topics.

### BRIEF DESCRIPTION OF THE DRAWINGS

Exemplary embodiments of the present disclosure will be described in detail based on the following figures, wherein:

FIG. 1 is a system diagram illustrating the configuration of a display control system according to an exemplary embodiment of the disclosure;

FIG. 2 is a block diagram illustrating the hardware configuration of a management server in the exemplary embodiment of the disclosure;

FIG. 3 is a block diagram illustrating the functional configuration of the management server in the exemplary embodiment of the disclosure;

FIG. 4 is a flowchart of the display control system in the exemplary embodiment of the disclosure;

FIGS. 5A to 5D are each a view illustrating an example display screen of a terminal apparatus in the exemplary embodiment of the disclosure;

FIGS. 6A to 6C are each a view illustrating an example display screen of a different terminal apparatus in the exemplary embodiment of the disclosure;

FIGS. 7A and 7B are each a view illustrating an example display screen displayed on the different terminal apparatus;

FIGS. 8A to 8C are each a view illustrating an example digest displayed on the different terminal apparatus;

FIGS. 9A and 9B are views respectively illustrating an example proceedings memo and an example digest displayed on the different terminal apparatus;

FIGS. 10A and 10B are views respectively illustrating an example selection window and an example digest displayed on the different terminal apparatus;

FIG. 11 is a table illustrating examples of estimated thoughts of a general user; and

FIG. 12 is a table illustrating examples of advice point detection.

### DETAILED DESCRIPTION

An exemplary embodiment of the disclosure will be described in detail with reference to the drawings.

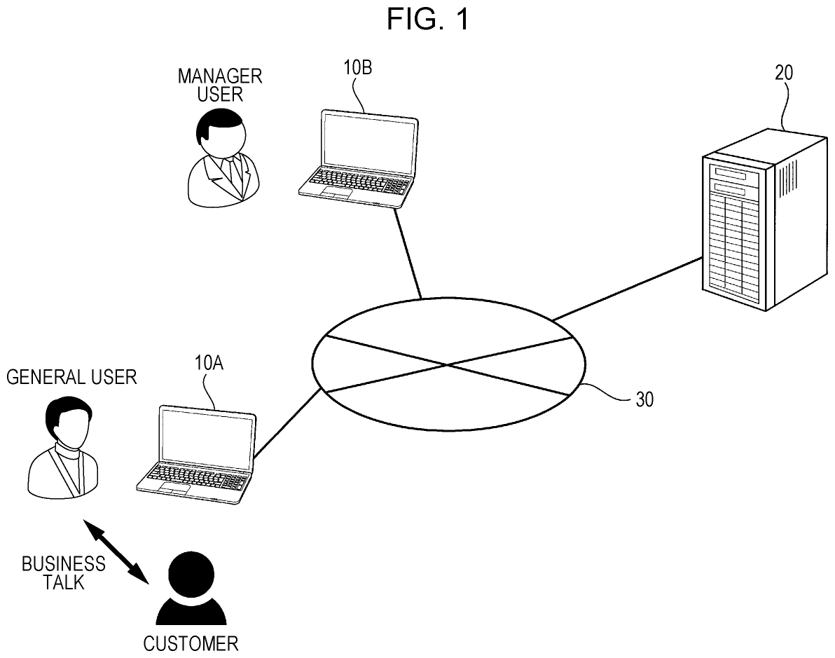

FIG. 1 is a system diagram illustrating the configuration of a display control system of an exemplary embodiment of the disclosure.

As illustrated in FIG. 1, the display control system of the exemplary embodiment of the disclosure includes a management server 20 that is an information processing apparatus and terminal apparatuses 10A and 10B that are each an information processing apparatus such as a personal computer (hereinafter, abbreviated as a PC), a notebook computer, a smartphone, or a tablet terminal. The management server 20 and the terminal apparatuses 10A and 10B are mutually connected via the Internet 30.

The display control system of this exemplary embodiment, for example, enables a general user such as a salesperson who is a user using the terminal apparatus 10A to access the management server 20 during a business talk with a different person such as a customer and thereby to be given advice in real time from an manager user who is a remote third party using the terminal apparatus 10B.

The terminal apparatus 10A is an information processing apparatus used for inputting the content of a talk such as the content of the business talk as proceedings information while the general user is talking with the different person such as the customer. The proceedings information may be input with a keyboard manually or using voice. An input device capable of converting input data to text is used for the input. The management server 20 is an information processing apparatus having editing software to perform digest display of information regarding the digest of the proceedings information thus input. The terminal apparatus 10B is an information processing apparatus for real-time displaying of the proceedings information input from the terminal apparatus 10A and for performing the digest display of the digest information of the proceedings information as occasion demands. Note that the terminal apparatus 10B is not allowed to edit the proceedings information input from the terminal apparatus 10A.

The term “proceedings information” denotes information indicating the content of a talk such as a business talk or a talk at the meeting. For example, when the content of a talk such as a business talk or a talk at the meeting is displayed on the screen by using text, the text is the proceedings information. The term “digest information” denotes information indicating the digest of the content of the talk such as the business talk or the talk at the meeting. For example, the digest information denotes such information that enables a reader to know, in a short time, the content of the talk such as the business talk or the talk at the meeting and that is displayed on the screen by using text.

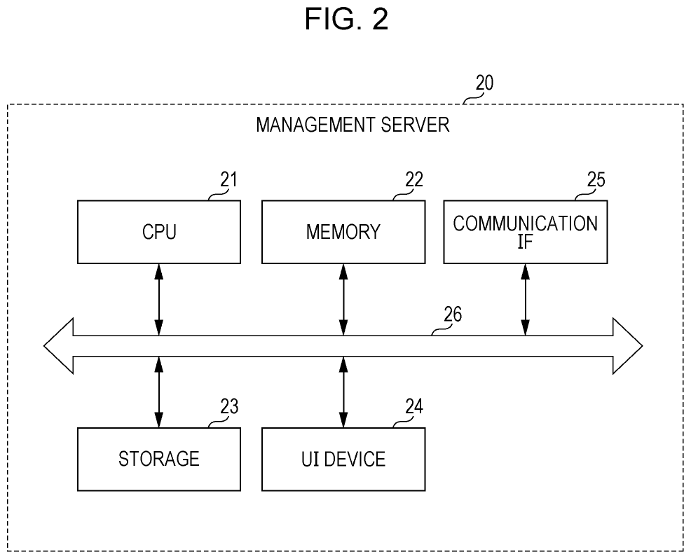

FIG. 2 illustrates the hardware configuration of the management server 20 in the display control system of this exemplary embodiment.

As illustrated in FIG. 2, the management server 20 includes a central processing unit (CPU) 21, a memory 22, a storage 23 such as a hard disk drive (HDD), a communication interface (IF) 25 that transmits and receives data with external apparatuses such as the terminal apparatuses 10A and 10B via the Internet 30, and a user interface (UI) device 24 including a touch panel or a liquid crystal display as well as a keyboard. These components are connected to each other with a control bus 26 interposed therebetween.

The CPU 21 is a processor that controls the operation of the management server 20 by performing predetermined processing in accordance with a control program stored in the memory 22 or the storage 23. In the description of this exemplary embodiment, the CPU 21 reads out and runs the control program stored in the memory 22 or the storage 23; however, the program may be provided to the CPU 21 in such a manner as to be stored in a storage medium such as a compact disc read-only memory (CD-ROM).

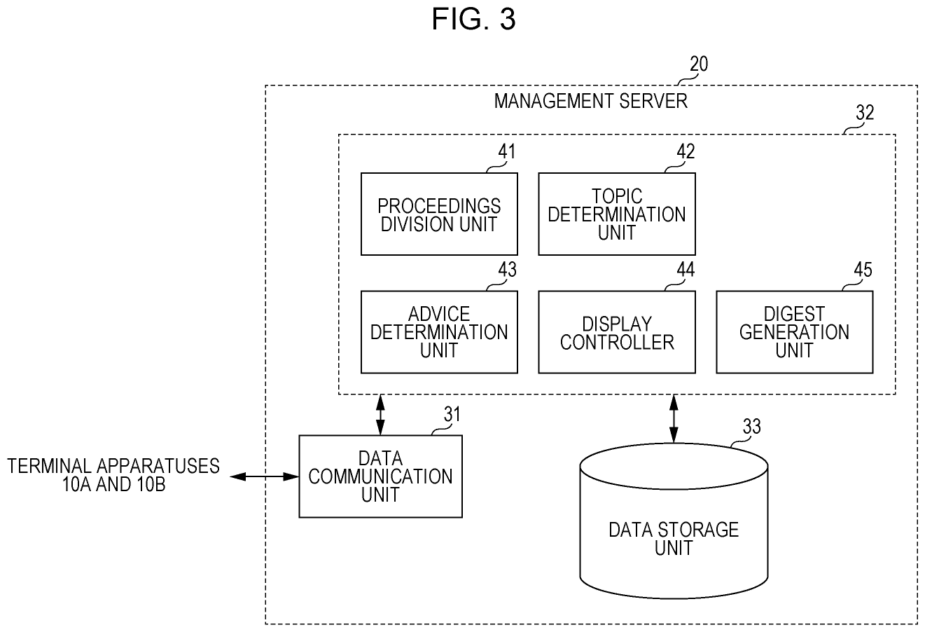

FIG. 3 is a block diagram illustrating the functional configuration of the management server 20 implemented by running the control program.

As illustrated in FIG. 3, the management server 20 of this exemplary embodiment includes a data communication unit 31, a controller 32, and a data storage unit 33.

The data communication unit 31 performs data communication with the terminal apparatuses 10A and 10B via the Internet 30.

The controller 32 controls the operation of the management server 20 and includes a proceedings division unit 41, a topic determination unit 42, an advice determination unit 43, a display controller 44, and a digest generation unit 45.

The data storage unit 33 stores various pieces of data such as the proceedings information. The data storage unit 33 stores pieces of proceedings information each divided into pieces of proceedings information on the basis of, for example, a customer, a user, a role, or a date.

The display controller 44 performs control of screens displayed on the terminal apparatuses 10A and 10B.

The proceedings division unit 41 divides the proceedings information regarding the contents of an ongoing talk input from the terminal apparatus 10A into elements of sentences or paragraphs by using a publicly known natural language processing technology.

The topic determination unit 42 determines a topic by using the publicly known natural language processing technology for each sentence or paragraph resulting from the division.

If a sentence or paragraph before or after a sentence or paragraph having a determined topic has a topic that is related to the determined topic and, for example, that is determined to be identical to the determined topic, the topic determination unit 42 associates the sentence or paragraph having the determined topic with the previous or following sentence or paragraph and stores the associated sentences or paragraphs in the data storage unit 33. In addition, if a sentence or paragraph in past proceedings information stored in the data storage unit 33 has a topic that is related to the determined topic and, for example, that is determined to be identical to the determined topic, the topic determination unit 42 associates the sentence or paragraph having the determined topic with the sentence or paragraph in the past proceedings information and stores the associated sentences or paragraphs in the data storage unit 33. The topic determination unit 42 may also associate the sentence or paragraph having the determined topic with information acquired from an external server and other than the proceedings information, such as business talk information, and store the associated sentence or paragraph and information in the data storage unit 33. This enables the digest display to be performed on the digest information associated with a topic requiring advice even for proceedings information having a transitioned and incontinuous content.

The display controller 44 performs real-time displaying of the proceedings information input from the terminal apparatus 10A on the display screen of the terminal apparatus 10B and simultaneously displays the information regarding the topic determined by the topic determination unit 42, for each sentence or paragraph in the proceedings information.

For each sentence or paragraph resulting from the division and having the determined topic in the input proceedings information, the advice determination unit 43 determines whether a content requiring advice from the manager user is included in the sentence or paragraph and an advice point is detected therein. This enables the manager user to efficiently monitor the proceedings information input by the remote general user.

If the advice determination unit 43 determines that a content requiring advice from the manager user is included in the input proceedings information, that is, an advice point is detected, the display controller 44 displays an advice flag (described later) in the part including the detected advice point on the display screen for displaying the ongoing proceedings information on the terminal apparatus 10B. The part corresponds to the sentence or paragraph determined to include a content requiring advice. That is, the display controller 44 reports, on the display screen of the terminal apparatus 10B, that the content requiring advice from the manager user is included in the proceedings information and that advice from the manager user is required. This enables the manager user to make sure of a point for advice.

Specifically, the advice determination unit 43 determines whether a content requiring advice from the manager user is included and whether an advice point is detected, on the basis of the transition of the topic in the input proceedings information, time elapsed in the proceedings, reactions of the customer or the general user, the thought of the general user, the circumstances of a talk such as a business talk, the goal of a talk such as a business talk, the aim of a talk such as a business talk, the history of past advice and receptiveness thereof, and the history of topics in the past business talks.

If it is determined that an advice point is detected, the display controller 44 displays a selection window for selecting whether to perform the digest display for displaying the digest information of the proceedings information separately from the display window for displaying the ongoing proceedings information on the terminal apparatus 10B.

The digest generation unit 45 generates a digest in such a manner that the display mode of the digest information is changed on the basis of a relationship between topics in the ongoing proceedings information, that is, a relationship between the topic of the sentence or paragraph including the detected advice point and the topic of the previous or following sentence or paragraph. The digest information is information that represents the input proceedings information and that is displayed on the display screen of the terminal apparatus 10B.

Specifically, the digest generation unit 45 generates a digest in such a manner that the display mode of the digest information of the proceedings information to be displayed on the display screen of the terminal apparatus 10B is changed on the basis of a relationship between the topics determined by the topic determination unit 42. In other words, the digest generation unit 45 generates the digest in such a manner that the display mode of the digest information of the proceedings information is changed on the basis of the relationship between the topic of the sentence or paragraph including the advice point detected by the advice determination unit 43 and the topic of the previous or following sentence or paragraph.

Specifically, if the topic of the sentence or paragraph including the detected advice point has appeared for the first time in the ongoing proceedings information, the digest generation unit 45 generates the digest by using, as the digest information, text in several lines before and after the sentence or paragraph including the detected advice point. At this time, the digest generation unit 45 may generate the digest in such a manner that animation display is performed in the order of input on pieces of digest information regarding the text in several lines before and after the sentence or paragraph including the detected advice point.

If a topic identical to the topic of the sentence or paragraph including the detected advice point has appeared previously in the ongoing proceedings information, the digest generation unit 45 generates a digest by using, as the digest information, the sentence or paragraph having the topic identical to the topic of the sentence or paragraph including the detected advice point.

The display controller 44 performs control to display the digest generated by the digest generation unit 45 on the display screen of the terminal apparatus 10B.

The digest generation unit 45 detects the absence of the manager user and generates a digest by using, as the digest information, the proceedings information input from the terminal apparatus 10A during the absence of the manager user.

Specifically, for example, in response to the detection of the advice point, the display controller 44 displays the selection window for inquiring whether to perform the digest display of the digest information of the proceedings information on the terminal apparatus 10B and for selecting whether to perform the digest display. The digest generation unit 45 generates the digest in such a manner that the display mode of the digest information of the proceedings information to be displayed on the display screen of the terminal apparatus 10B is changed on the basis of elapsed time from the displaying of the selection window to the selection of Yes, that is, elapsed time from the inquiry about whether to perform the digest display to the input of an instruction. The enables the manager user to know a topic of a talk during the absence of the manager user.

The digest generation unit 45 also generates the digest in such a manner as to change the amount of the digest information to be displayed before and after the sentence or paragraph including the detected advice point on the basis of elapsed time from the displaying of the selection window for selecting whether to perform the digest display on the terminal apparatus 10B to the selection of Yes. That is, the digest generation unit 45 generates the digest in such a manner that the longer the elapsed time from the displaying of the selection window to the selection of Yes, the larger the amount of the displayed digest information.

In other words, the digest generation unit 45 generates the digest in such a manner as to decide the digest range and the way of displaying that are optimum for the manager user to appropriately give the general user advice, by using the proceedings information input from the terminal apparatus 10A. The display controller 44 displays the digest generated by the digest generation unit 45 in the digest display window of the terminal apparatus 10B. Performing the digest display of the proceedings information enables the manager user to know the content of the talk in a shorter time than in a case where the manager user reads all the pieces of proceedings information and also to give the general user appropriate advice.

The digest generation unit 45 generates the digest in such a manner as to change the amount of the digest information before and after the sentence or paragraph including the detected advice point and the content requiring advice. The digest generation unit 45 generates the digest to have an amount corresponding to a period of time within a period of time designated by the manager user. This enables the manager user to know the content of the talk having an amount corresponding to the period of time within the period of time designated in advance and to give the general user appropriate advice.

If the selection to perform the digest display is made from the terminal apparatus 10B, the display controller 44 displays the digest display window for performing the digest display of the digest information of the proceedings information separately from the display window for displaying the ongoing proceedings information. The display controller 44 also displays the digest display window on the terminal apparatus 10B separately from an input window for inputting advice. The display controller 44 functions as a receiver that receives the advice from the manager user in the terminal apparatus 10B. Inputting the advice in the input window enables the remote manager user to give the general user the advice in real time. This enables the general user to receive the advice from the remote manager user and at the same time concentrate on a talk with a different person such as a customer.

The display controller 44 is configured to input advice for a selected part of the proceedings information displayed on the display screen of the terminal apparatus 10B. The display controller 44 is also configured to enable the manager user to not only directly input text for advice but also select advice from advice candidates stored in the data storage unit 33 or the external server. The display controller 44 is also configured to enable whether advice is used in the past proceedings information to be determined and to report to that effect to the terminal apparatus 10B. This enables the manager user to efficiently work for advice.

In response to receiving the advice from the manager user in the terminal apparatus 10B, the display controller 44 displays the advice from the manager user on the display screen of the terminal apparatus 10A. At this time, the display controller 44 displays, for example, a balloon pointing at the part where the advice is given in the proceedings information together with the advice from the manager user on the display screen of the terminal apparatus 10A. The display controller 44 displays the balloon to enable the general user to recognize the part where the advice is given in the proceedings information. The display controller 44 performs control to display the content of the advice in response to clicking the balloon. This enables the general user to visually know the part where the advice is given in the proceedings information.

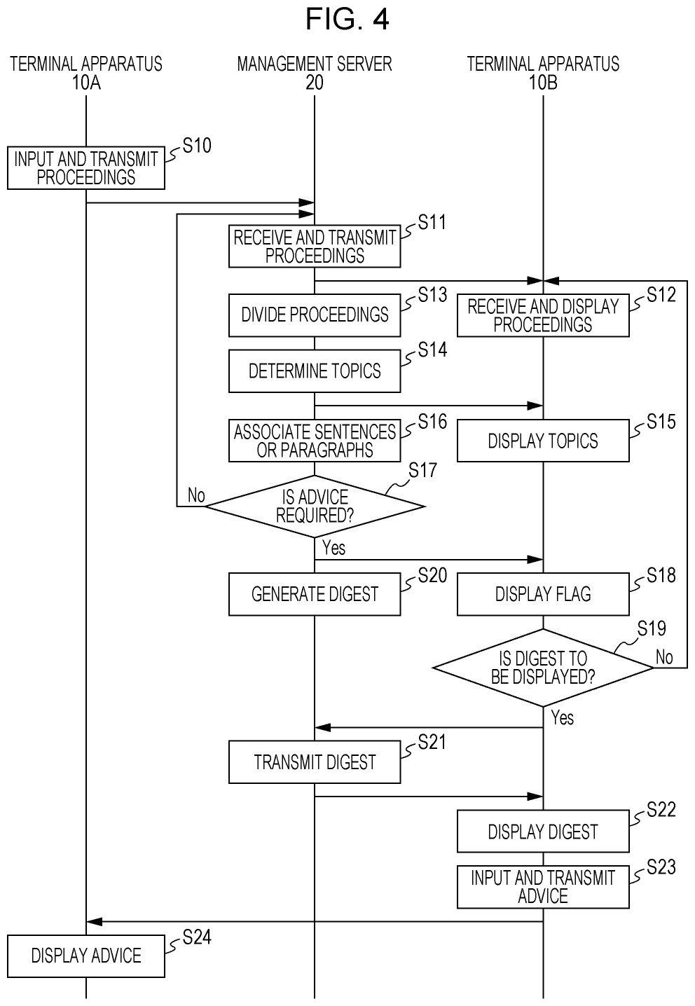

The operations of the terminal apparatus 10A, the management server 20, and the terminal apparatus 10B in the display control system of this exemplary embodiment will be described in detail with reference to FIGS. 4 to 6C.

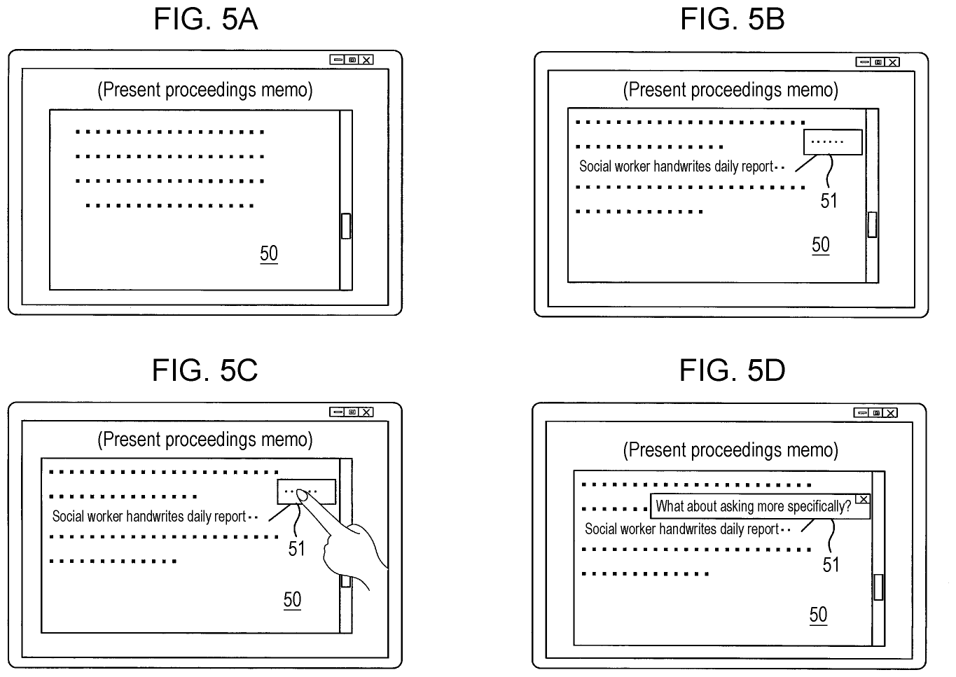

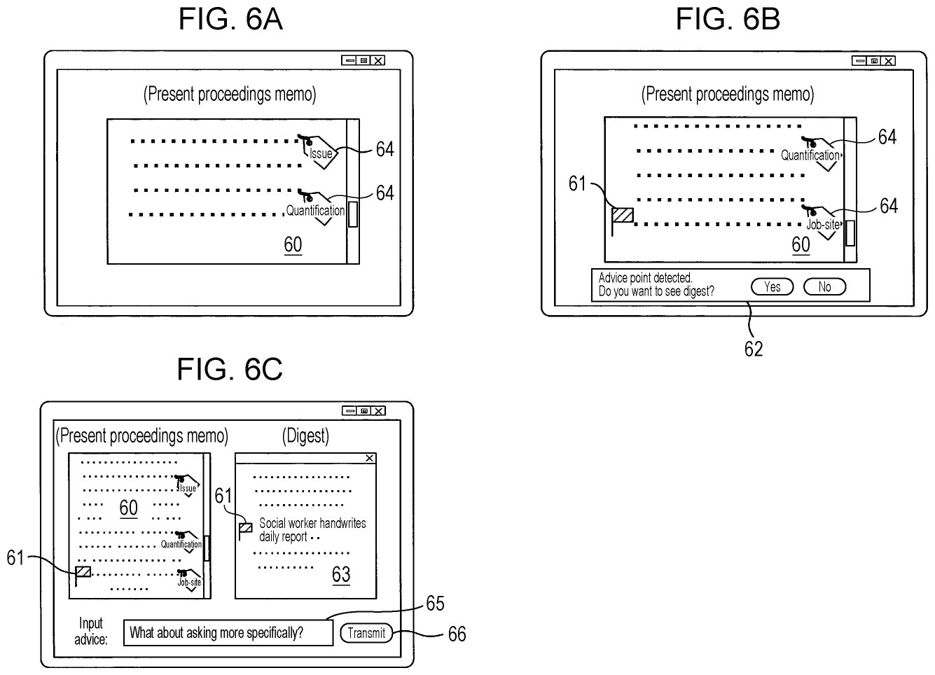

FIG. 4 is a flowchart illustrating the operation flow of the display control system. FIGS. 5A to 5D are each a view illustrating the display screen of the terminal apparatus 10A of the general user. FIGS. 6A to 6C are each a view illustrating the display screen of the terminal apparatus 10B of the manager user.

In step S10, as illustrated in FIG. 5A, the present proceedings memo serving as the ongoing proceedings information is input in a proceedings memo window 50 in the terminal apparatus 10A while the general user is talking with a customer. In response to this, in step S11, the input proceedings information is transmitted from the terminal apparatus 10A to the terminal apparatus 10B via the management server 20. In step S12, the display controller 44 then performs control to display a proceedings memo window 60 on the display screen of the terminal apparatus 10B and to perform real-time display of the present proceedings memo input from the terminal apparatus 10A in the proceedings memo window 60, as illustrated in FIG. 6A.

In step S13, the proceedings division unit 41 then extracts a difference every time a proceedings memo is input from the terminal apparatus 10A and divides the input proceedings information into elements of sentences or paragraphs by using a publicly known natural language processing technology.

In step S14, the topic determination unit 42 then determines topics by using the publicly known natural language processing technology, for the respective sentences or paragraphs resulting from the division.

In step S15, as illustrated in FIG. 6A, the display controller 44 then displays the proceedings memo input from the terminal apparatus 10A in the proceedings memo window 60 of the terminal apparatus 10B in real time and simultaneously displays topic tags 64 each assigned to a corresponding one of the topics determined per sentence or paragraph.

To assign the topic tag 64, for example, a topic is determined per sentence or paragraph by the machine learning, and then each sentence or paragraph is tagged with a topic tag such as a job-site tag, a quantification tag, or an issue tag. Specifically, in this example, correct data (also referred to as training data) is prepared in advance, and the topic determination unit 42 determines a topic for each sentence or paragraph by using the correct data and assigns a topic tag 64 to the sentence or paragraph.

Specifically, proceedings information is first divided into elements of sentences or paragraphs and manually assigns topic tags to the respective sentences or paragraphs. For example, the sentence “The business department needs to change the way of working, aiming at sales increase.” is tagged with an issue tag. The sentence “The customer has not yet decided the budged clearly.” is tagged with a quantification tag. The sentence “The business department still exchanges paper documents.” is tagged with a job-site tag. Correct data is thus prepared in advance. The correct data is input in a module for machine learning such as Bert, and then a model is generated.

The proceedings information is then input in the generated model. The topic determination unit 42 refers to the correct data for each sentence or paragraph in the input proceedings information, determines a topic similar to the machine learning result, and assigns a topic tag 64 to the sentence or paragraph.

In step S16, the topic determination unit 42 then associates a sentence or paragraph having the determined topic with a sentence or paragraph having a topic related to and identical to the topic of the sentence or paragraph having the determined topic or associates the sentence or paragraph having the determined topic with a sentence or paragraph, in the past proceedings information, having a topic related to and identical to the topic of the sentence or paragraph having the determined topic, or the like. The topic determination unit 42 stores the associated pieces of data in the data storage unit 33.

In other words, the topic determination unit 42 associates a sentence or paragraph assigned a topic tag 64 with sentences or paragraphs assigned the related topic tags 64 before or after the sentence or paragraph assigned the topic tag 64. In addition, the topic determination unit 42 associates a sentence or paragraph assigned a topic tag 64 with a sentence or paragraph assigned a related topic tag 64 in the past proceedings information stored in the data storage unit 33. The topic determination unit 42 may also associate a sentence or paragraph assigned a topic tag 64 with information acquired from the external server and other than the proceedings information, such as business talk information. This enables the digest display to be performed on the digest information in association with a topic requiring advice even for proceedings information having a transitioned and incontinuous content.

In step S17, the advice determination unit 43 then determines, for each sentence or paragraph assigned the topic tag 64 in the input proceedings information, whether advice from the manager user is required and whether an advice point is detected. If an advice point is not detected, the processing returns to step S11.

If it is determined in step S17 that a content requiring advice from the manager user is included in the input proceedings information, that is, an advice point is detected, the display controller 44 displays, in step S18, an advice flag 61 in the part where the advice point is detected in the proceedings memo window 60 of the terminal apparatus 10B as illustrated in FIG. 6B. That is, on the display screen of the terminal apparatus 10B, the display controller 44 reports that a content requiring advice from the manager user is included in the present proceedings memo and that advice from the manager user is required.

In step S19, the display controller 44 then displays, on the display screen of the terminal apparatus 10B, a selection window 62 for selecting whether to perform the digest display of the digest information of the proceedings information separately from the proceedings memo window 60, as illustrated in FIG. 6B.

In addition, if it is determined in step S17 that a content requiring advice from the manager user is included in the input proceedings memo, that is, if it is determined that an advice point is detected, the digest generation unit 45 generates a digest in step S20 as the digest information of the proceedings information on the basis of a relationship with the topic tag in the sentence or paragraph including the detected advice point.

If the topic tag 64 in the sentence or paragraph including the detected advice point has appeared for the first time in the ongoing proceedings information, the digest generation unit 45 generates the digest by using, as the digest information, the text in several lines before and after the sentence or paragraph including the detected advice point. In addition, if a topic tag 64 identical to the topic tag 64 in the sentence or paragraph including the detected advice point has appeared previously in the ongoing proceedings information, the digest generation unit 45 generates the digest by using, as the digest information, the sentence or paragraph having the topic tag 64 identical to the topic tag 64 in the sentence or paragraph including the detected advice point.

The digest generation unit 45 also detects the absence of the manager user and then generates a digest of the digest information of a proceedings memo input during the absence of the manager user. Specifically, the digest generation unit 45 generates the digest in such a manner that the display mode of the digest information of the proceedings memo to be displayed on the display screen of the terminal apparatus 10B is changed on the basis of elapsed time from the displaying of selection window 62 as illustrated in FIG. 6B to the selection of Yes.

The digest generation unit 45 generates the digest in such a manner as to change the amount of the digest information to be displayed before and after the sentence or paragraph including the detected advice point on the basis of the elapsed time from the displaying of the selection window 62 to the selection of Yes. In other words, the digest generation unit 45 generates the digest in such a manner that the longer the elapsed time from the displaying of the selection window 62 to the selection of Yes, the larger the amount of the digest information to be displayed.

If No is selected in the selection window 62 as illustrated in FIG. 6B, the processing returns to step S12. If Yes is selected in the selection window 62 as illustrated in FIG. 6B, the data communication unit 31 transmits the digest generated by the digest generation unit 45 to the terminal apparatus 10B in step S21.

In step S22, the display controller 44 then displays the digest generated by the digest generation unit 45 on the display screen of the terminal apparatus 10B. At this time, as illustrated in FIG. 6C, the display controller 44 displays a digest display window 63 on the display screen of the terminal apparatus 10B separately from the proceedings memo window 60 displaying the present proceedings memo. The display controller 44 also performs control to display, in the digest display window 63, the digest generated by the digest generation unit 45. The proceedings memo window 60, an input window 65 for inputting advice displayed separately from the digest display window 63, and a Transmit button 66 for transmitting the advice to the terminal apparatus 10A are displayed on the display screen of the terminal apparatus 10B.

In step S23, the information regarding the advice from the manager user is transmitted to the terminal apparatus 10A in response to inputting the advice in the input window 65 of the terminal apparatus 10B and pressing the Transmit button 66, as illustrated in FIG. 6C.

In step S24, the display controller 44 then displays the advice from the manager user in the proceedings memo window 50 of the terminal apparatus 10A. Specifically, in response to receiving the advice from the terminal apparatus 10B, the display controller 44 displays, for example, a balloon 51 pointing at the part where the advice is given in the present proceedings memo in the proceedings memo window 50 of the terminal apparatus 10A as illustrated in FIG. 5B. The display controller 44 displays the balloon 51 to enable the general user to recognize the part where the advice is given. The display controller 44 performs the following control. In response to clicking on the balloon 51 as illustrated in FIG. 5C, the display controller 44 displays the content of the advice transmitted from the terminal apparatus 10B in the balloon 51 as illustrated in FIG. 5D. In response to clicking Close “x”, the content of the advice is not displayed.

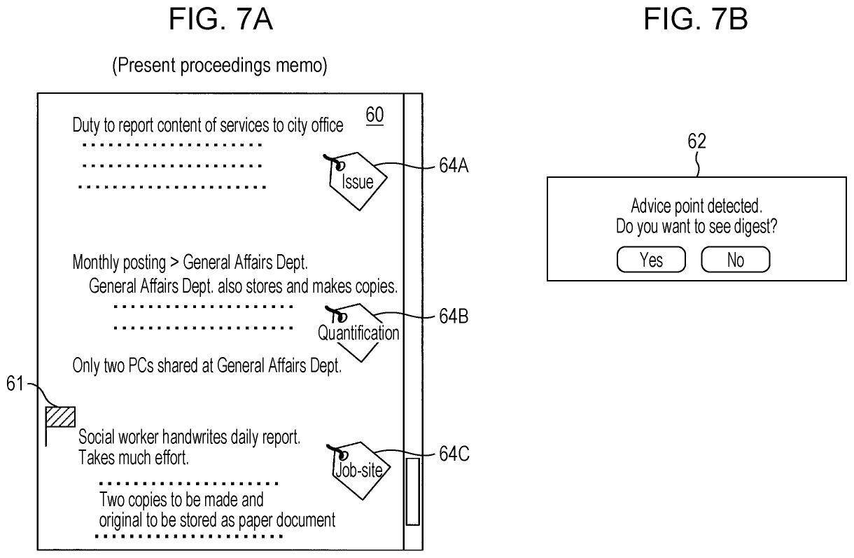

Examples of the digest display of the proceedings memo displayed on the terminal apparatus 10B will be described specifically on the basis of FIGS. 7A to 10B.

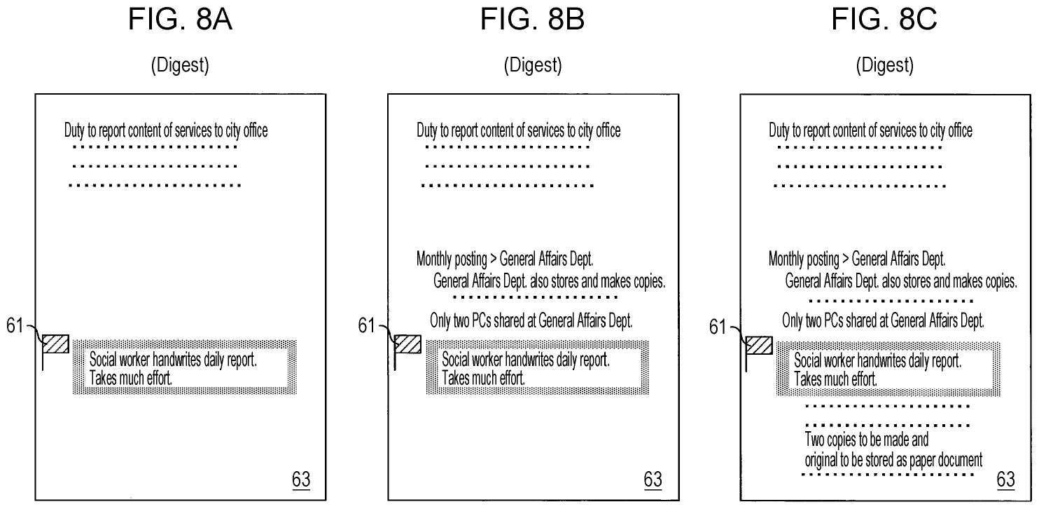

First, a digest display example in which a topic tag has appeared for the first time in the sentence including the detected advice point in the present proceedings memo input from the terminal apparatus 10A will be described by using FIGS. 7A to 8C.

As illustrated in FIG. 7A, a present proceedings memo displaying the ongoing proceedings information input by the general user from the terminal apparatus 10A is displayed in the proceedings memo window 60 on the terminal apparatus 10B of the manager user in real time. Sentences or paragraphs each tagged with a corresponding one of the topic tags 64 such as an issue tag 64A, a quantification tag 64B, and a job-site tag 64C are displayed in the proceedings memo window 60. In response to the detection of the advice point in the present proceedings memo, the advice flag 61 is displayed in the part including the detected advice point in the proceedings memo window 60.

A message indicating that an advice point has been detected is then displayed as illustrated in FIG. 7B, and the selection window 62 for selecting whether to perform the digest display of the proceedings memo is displayed.

In response to the selection of Yes in the selection window 62 in FIG. 7B, the digest generation unit 45 generates a digest. Since the job-site tag 64C assigned to the sentence provided with the advice flag 61 has appeared for the first time in the present proceedings memo, the digest generation unit 45 generates the digest by using, as the digest information, the text in several lines before and after the sentence with the advice flag 61. The digest is generated, for example, for animation display in the order of input. The display controller 44 then displays, in the digest display window 63, the digest generated by the digest generation unit 45. That is, in the digest display window 63 of the terminal apparatus 10B, the display controller 44 displays the transition in the input history of the proceedings memo. A seek bar or the like may be used to control the digest display in the digest display window 63 through the manager user's operation.

Specifically, for example, as illustrated in FIG. 8A, the display controller 44 displays a sentence with the advice flag 61 in the proceedings memo in the digest display window 63 of the terminal apparatus 10B. As illustrated in FIG. 8B, the display controller 44 then displays the text in four lines before the sentence with the advice flag 61 in the proceedings memo, and as illustrated in FIG. 8C, the display controller 44 thereafter displays the text in four lines after the sentence with the advice flag 61 in the proceedings memo. That is, the display controller 44 performs the digest display of the digest information of the proceedings memo in the digest display window 63 of the terminal apparatus 10B to enable the manager user to know how a topic transitions to the topic with the advice flag 61 in the proceedings memo.

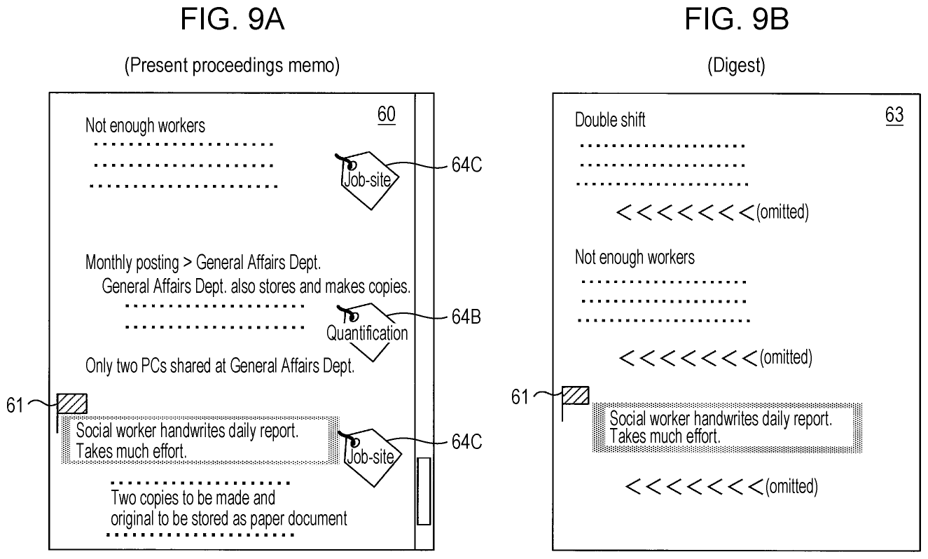

A digest display example where a topic tag of a sentence including a detected advice point in the present proceedings memo input from the terminal apparatus 10A has previously appeared in the ongoing proceedings memo will be described by using FIGS. 9A and 9B.

As illustrated in FIG. 9A, the present proceedings memo input by the general user from the terminal apparatus 10A is displayed in real time in the proceedings memo window 60 on the terminal apparatus 10B of the manager user. Sentences or paragraphs each tagged with a corresponding one of the job-site tag 64C, the quantification tag 64B, and the job-site tag 64C are displayed in the proceedings memo window 60. In response to the detection of an advice point in the present proceedings memo, the advice flag 61 is displayed in the part including the detected advice point in the proceedings memo window 60.

As illustrated in FIG. 7B, the message indicating that an advice point has been detected is displayed, and the selection window 62 for selecting whether to perform the digest display of the proceedings memo is displayed.

In response to the selection of Yes in the selection window 62 in FIG. 7B, the digest generation unit 45 generates a digest. Since a job-site tag 64C identical to the job-site tag 64C assigned to the sentence with the advice flag 61 has previously appeared in the ongoing proceedings memo, the digest generation unit 45 generates the digest by using, as the digest information, the sentence with the job-site tag 64C identical to the job-site tag 64C assigned to the sentence with the advice flag 61. Specifically, the digest generation unit 45 generates the digest in such a manner as to display only one or more sentences with the job-site tag 64C identical to the job-site tag 64C assigned to the sentence with the advice flag 61 and omit one or more sentences therebetween.

The display controller 44 then displays the digest generated by the digest generation unit 45 in the digest display window 63. That is, the display controller 44 displays only one or more sentences with the job-site tag 64C identical to the job-site tag 64C assigned to the sentence with the advice flag 61 and omits one or more sentences therebetween.

The omitted one or more sentences or paragraphs may be displayed in a foldable and developable manner. Displaying the omitted one or more sentences or paragraphs in the thus foldable and developable manner enables the manager user to make sure of what the content of the talk regarding the topic with the advice flag 61 is like even if the topic is different from the topic of the sentence with the advice flag 61.

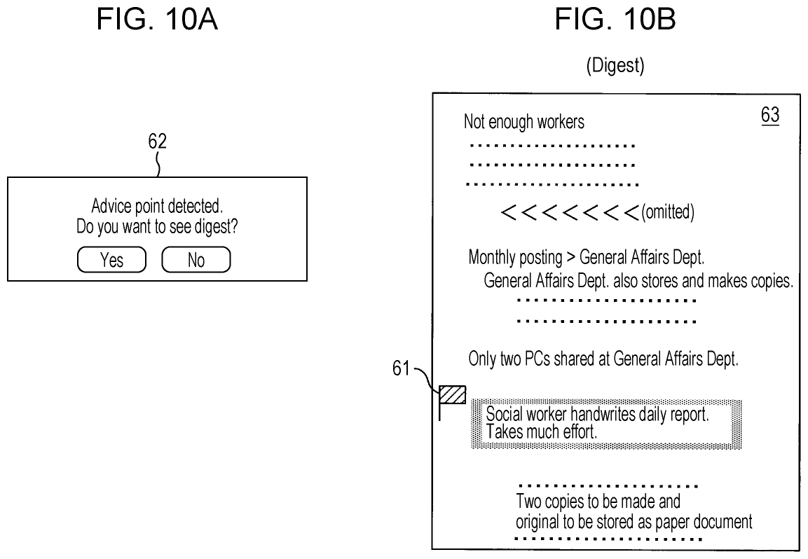

A digest display example of the proceedings memo written during the absence of the manager user will be described by using FIGS. 10A and 10B.

In response to the detection of the advice point in the present proceedings memo input from the terminal apparatus 10A, the message indicating that an advice point has been detected is displayed as illustrated in FIG. 10A. The selection window 62 for selecting whether to perform the digest display of the proceedings memo is displayed on the display screen of the terminal apparatus 10B.

The display mode of the digest display is changed on the basis of time elapsed before the selection of Yes in the selection window 62. Specifically, the display mode of the digest is changed in such a manner that the longer elapsed time from the displaying of the selection window 62 to the selection of Yes in the selection window 62, the larger the number of lines before and after the sentence provided with the advice flag 61 and including the detected advice point as illustrated in FIG. 10B. Changing the display mode of the digest in this manner enables the manager user to efficiently make sure of what the content of the talk regarding the topic with the advice flag 61 is like.

The display mode of the digest may be changed on the basis of a relationship between the time elapsed before the selection of Yes in the selection window 62 as described above and the topic tag of the sentence including the detected advice point as described above. In other words, the display mode of the digest may be changed in such a manner that the longer elapsed time from the displaying of the selection window 62 to the selection of Yes in the selection window 62, the larger the number of lines of sentences that have a topic tag identical to the topic tag of the sentence including the detected advice point and that are located before and after the sentence provided with the advice flag 61 and including the detected advice point.

An example of detecting the advice point in step S17 above will be described by using an example of detecting an advice point by estimating the thought of the general user.

In this exemplary embodiment, while the general user is talking with a different person such as a customer, the content of the proceedings that is the content of the talk is input as text by using the terminal apparatus 10A, and simultaneously the content of conversation that is the content of the talk in the proceedings is acquired from the voice. The management server 20 estimates the thought of the general user on the basis of the content of the proceedings input as text from the terminal apparatus 10A and the content of the conversation acquired from the voice and thereby detects an advice point.

The advice determination unit 43 estimates the thought of the general user by using input data 1 representing the process of inputting the proceedings, input data 2 obtained by comparing the process of inputting the proceedings with the content of the conversation in the proceedings, and input data 3 representing the content of the conversation in the proceedings. The advice determination unit 43 determines whether a content requiring advice from the manager user is included in any one of the sentences or paragraphs for each sentence or paragraph on the basis of the estimated thought of the general user. If a content requiring advice is included, the advice determination unit 43 determines that an advice point is detected. The data storage unit 33 stores pieces of data accumulated in such a manner that the input data 1 representing the process of inputting the proceedings, the input data 2 obtained by comparing the process of inputting the proceedings with the content of the conversation in the proceedings, the input data 3 representing the content of the conversation in the proceedings, the result of the estimation of the thought of the general user, and an example advice are associated with each other by machine learning.

For example, if “the general user has corrected the content of the proceedings” in the process of inputting the proceedings in the terminal apparatus 10A, the advice determination unit 43 estimates that “the general user recognized that they have wrongly understood” as the thought of the general user. If “the general user has changed the order of the proceedings text” in the process of inputting the proceedings in the terminal apparatus 10A, the advice determination unit 43 estimates that “the general user is coordinating thoughts and ideas” as the thought of the general user. If “there is no input in N seconds” in the process of inputting the proceedings in the terminal apparatus 10A, the advice determination unit 43 estimates that “the general user does not know what to write” as the thought of the general user. If “the general user inputs proceedings text different from the content of the conversation” as the result of comparing the process of inputting the proceedings with the content of the conversation in the proceedings, the advice determination unit 43 estimates that “the general user has made a hypothesis and found something” as the thought of the general user. If “a content is included in both of the conversation and the proceedings” as the result of comparing the process of inputting the proceedings with the content of the conversation in the proceedings, the advice determination unit 43 estimates that “the general user determines that the part having the content is of great import” as the thought of the general user.

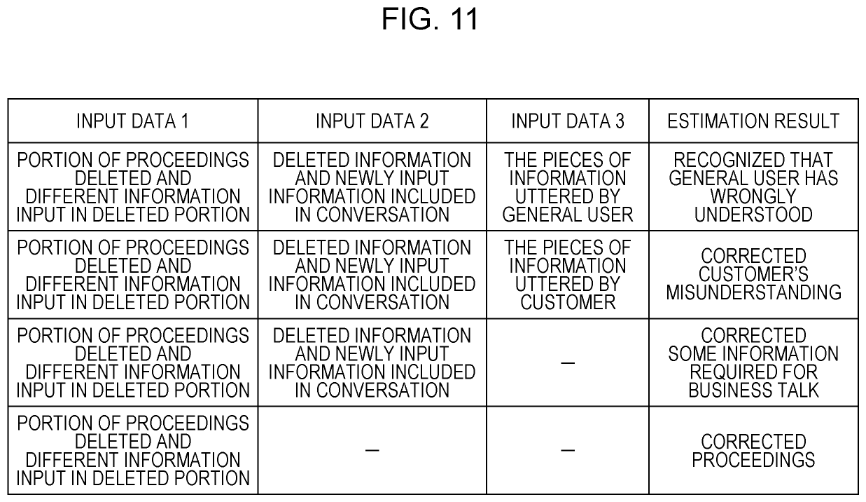

The advice determination unit 43 may also estimate the thought of the general user as illustrated in FIG. 11 by using the AND condition for pieces of data such as the input data 1 representing the process of inputting the proceedings, the input data 2 that is the result of comparison between the process of inputting the proceedings and the content of the conversation in the proceedings, and the input data 3 representing the content of the conversation in the proceedings. That is, the larger the number of pieces of input data, the higher estimation accuracy. If it is estimated that the general user has corrected the content of the proceedings, and if advice has been input for the corrected part, the display controller 44 displays a prompt for the deletion of the advice on the display screen of the terminal apparatus 10B. If it is estimated that the general user is coordinating thoughts and ideas, the display controller 44 performs control not to display the window for inputting advice or not to display the advice flag to avoid confusion.

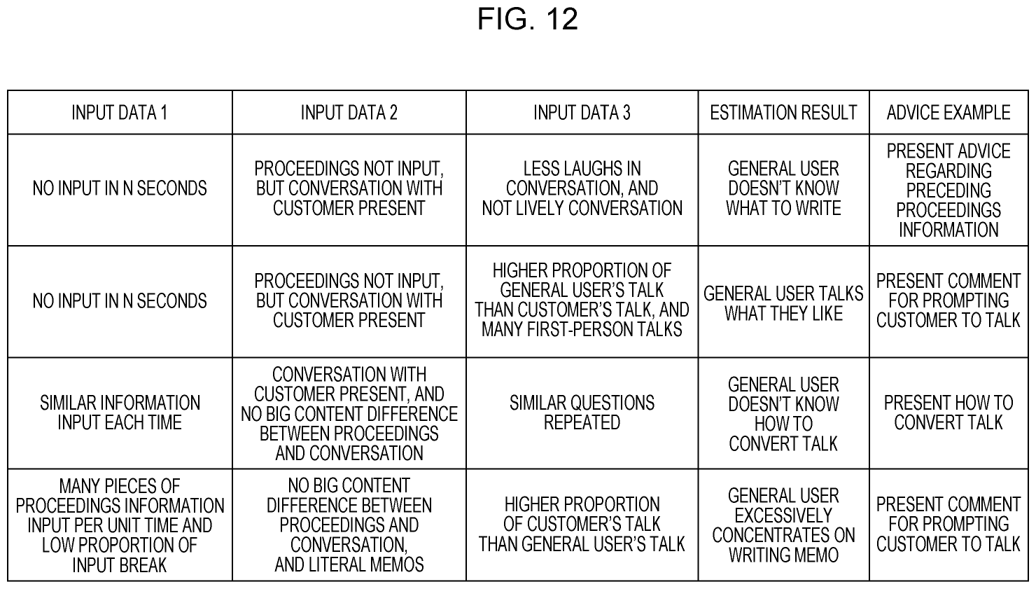

As illustrated in FIG. 12, the advice determination unit 43 estimates the thought of the general user such as the general user's idea, interpretation, or the like on the basis of the input data 1 representing the process of inputting the proceedings and input by the general user, the input data 2 obtained by comparing the process of inputting the proceedings with the content of the conversation in the proceedings, and the input data 3 representing the content of the conversation in the proceedings. The advice determination unit 43 then detects an advice point on the basis of the estimation result. The display controller 44 displays the advice flag 61 in the part that corresponds to a sentence or paragraph determined to include a content requiring advice and where an advice point is detected on the display screen for displaying the ongoing proceedings information on the terminal apparatus 10B. The display controller 44 displays not only the advice flag 61 but also the result of the estimation of the thought of the general user and an example of advice to the general user in the proceedings memo window 60 of the terminal apparatus 10B for displaying the ongoing proceedings information. This enables the manager user to give advice to be displayed on the terminal apparatus 10A with the thought of the general user taken into consideration. This also enables the general user to receive the advice from the remote manager user and simultaneously concentrate on a talk with a different person such as a customer in front of the general user.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory; and
a processor configured to
make a division of a content of a talk input by a user into talk content elements for each of topics of the talk content elements, and
change a display mode of digest information representing the content and to be displayed on a display screen of a third party, the display mode being changed on a basis of a relationship between the topics.

2. The information processing apparatus according to claim 1,
wherein the processor is configured to determine, for each of the talk content elements, whether a content requiring advice from the third party is included in any one of the talk content elements resulting from the division, and change the display mode of the digest information on a basis of a relationship between a topic of a talk content element determined to include the content requiring advice and a topic of a different talk content element.

3. The information processing apparatus according to claim 1,
wherein the processor is configured to, in response to first-time appearance of a topic of a talk content element including a content requiring advice in an ongoing talk, display, as the digest information, text regarding the topic in several lines before and after the talk content element including the content requiring advice, and in response to previous appearance of a topic identical to the topic of the talk content element including the content requiring advice in the ongoing talk, display the digest information regarding the identical topics.

4. The information processing apparatus according to claim 2,
wherein the processor is configured to, in response to first-time appearance of the topic of the talk content element including the content requiring advice in an ongoing talk, display, as the digest information, text regarding the topic in several lines before and after the talk content element including the content requiring advice, and in response to previous appearance of a topic identical to the topic of the talk content element including the content requiring advice in the ongoing talk, display the digest information regarding the identical topics.

5. An information processing apparatus comprising:
a memory; and
a processor configured to
make an inquiry about whether to display digest information regarding a talk between a user and a person different from the user, the inquiry being made, during the talk, to a third party remotely observing the talk, and change a display mode of the digest information to be displayed on a display screen of the third party, the display mode being changed on a basis of elapsed time from the inquiry to input of an instruction from the third party.

6. The information processing apparatus according to claim 5,
wherein the processor is configured to
change, on a basis of the elapsed time, an amount of the digest information to be displayed before and after a talk content element that is included in the talk and that is determined to include a content requiring advice.

7. The information processing apparatus according to claim 6,
wherein the processor is configured to increase the amount of the digest information as the elapsed time becomes longer.

8. The information processing apparatus according to claim 1,
wherein the processor is configured to report to the third party that a content requiring advice is included in one of the talk content elements.

9. The information processing apparatus according to claim 2,
wherein the processor is configured to report to the third party that a content requiring advice is included in one of talk content elements of a content of the talk.

10. The information processing apparatus according to claim 3,
wherein the processor is configured to report to the third party that a content requiring advice is included in one of talk content elements of a content of the talk.

11. The information processing apparatus according to claim 4,
wherein the processor is configured to report to the third party that a content requiring advice is included in one of talk content elements of a content of the talk.

12. The information processing apparatus according to claim 5,
wherein the processor is configured to report to the third party that a content requiring advice is included in one of talk content elements of a content of the talk.

13. The information processing apparatus according to claim 1,
wherein the processor is configured to
change an amount of the digest information before and after one of the talk content elements that includes a content requiring advice, the amount being changed to correspond to a period of time within a period of time designated by the third party.

14. The information processing apparatus according to claim 1,
wherein the processor is configured to determine whether a content requiring advice from the third party in a course of the talk is included in any one of the talk content elements resulting from the division, the content requiring advice being determined for each of the talk content elements on the basis of a thought of the user estimated on a basis of each talk content element input by the user.

15. The information processing apparatus according to claim 14,
wherein the processor is configured to display, on the display screen of the third party, a part including the content requiring advice in the talk content element.

16. The information processing apparatus according to claim 15,
wherein the processor is configured to display, on the display screen of the third party, the part including the content requiring advice and the estimated thought of the user.

17. The information processing apparatus according to claim 1, further comprising:
a receiver configured to receive advice from the third party,
wherein the processor is configured to, in response to receiving the advice from the third party, display the advice from the third party on a display screen of the user.

18. The information processing apparatus according to claim 17,
wherein the processor is configured to display, on the display screen of the user, the advice from the third party and a part including a content regarding which the advice is given in the talk content element.

19. A non-transitory computer readable medium storing a program causing a computer to execute a process comprising:
making a division of a content of a talk input by a user into talk content elements for each of topics of the talk content elements; and
changing a display mode of digest information representing the content and to be displayed on a display screen of a third party, the display mode being changed on a basis of a relationship between the topics.

20. A non-transitory computer readable medium storing a program causing a computer to execute a process comprising:
making an inquiry about whether to display digest information regarding a talk between a user and a person different from the user, the inquiry being made, during the talk, to a third party remotely observing the talk; and
changing a display mode of the digest information to be displayed on a display screen of the third party, the display mode being changed on a basis of elapsed time from the inquiry to input of an instruction from the third party.
